(19) United States
(12) Patent Application Publication
(10) Pub. No.: US 2011/0203870 A1
(43) Pub. Date: Aug. 25, 2011

(54) JET BRIDGE FALL PROTECTION ASSEMBLY

(75) Inventors: John P. Blomberg, Red Wing, MN (US); Scott C. Casebolt, St. Paul Park, MN (US); Matthew J. Blackford, Hastings, MN (US)

(73) Assignee: D B Industries, Inc.

(21) Appl. No.: 12/732,493

(22) Filed: Mar. 26, 2010

Related U.S. Application Data
(60) Provisional application No. 61/307,983, filed on Feb. 25, 2010.

(51) Int. Cl. A62B 35/00

(52) U.S. Cl. 182/3

(57) ABSTRACT

A fall protection system that includes at least one rail section, at least one shuttle and at least one connecting member is provided. The at least one rail section is configured and arranged to be coupled to a structure that changes in length. The at least one shuttle is configured and arranged to movably engage the at least one rail section. In addition, the at least one connecting member is configured and arranged to provide a connection point to the at least one shuttle.

### CROSS-REFERENCE TO RELATED APPLICATIONS

This Application claims priority to U.S. Provisional Application Ser. No. 61/307,983, same title herewith, filed on Feb. 25, 2010, which is incorporated in its entirety herein by reference.

### BACKGROUND

Fall protection and fall arrest systems that protect workers are used in work locations where a fall could cause injury or death. A typical fall arrest system includes a safety harness that is donned by the worker, a lifeline that is attached to the harness, and a support structure to which the lifeline is connected. This system works well in typical situations where a stationary stable support structure is available for attachment. However, it is desired in the art for a safety system where a stationary support is not available.

For the reasons stated above and for other reasons stated below which will become apparent to those skilled in the art upon reading and understanding the present specification, there is a need in the art for a protection assembly for workers required to work on an expanding and retracting housing without a stationary support structure available for use.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a fall protection system is provided. The fall protection system includes at least one rail section, at least one shuttle and at least one connecting member. The at least one rail section is configured and arranged to be coupled to a structure that changes in length. The at least one shuttle is configured and arranged to movably engage the at least one rail section. In addition, the at least one connecting member is configured and arranged to provide a connection point to the at least one shuttle.

### BRIEF DESCRIPTION OF THE DRAWINGS

The present invention can be more easily understood and further advantages and uses thereof more readily apparent, when considered in view of the detailed description and the following figures in which:

FIG. 1 is a top perspective view of a shuttle and rail of one embodiment of the present invention;

FIG. 2 is a side view of the shuttle and rail of FIG. 1;

FIG. 3 is front perspective view of the shuttle of FIG. 1 with a connecting member in a connecting position;

FIG. 4 is an exploded side perspective view of the shuttle of FIG. 3;

FIG. 5 is a bottom perspective view of the shuttle of FIG. 3;

FIGS. 6A through 6C are side view illustrations of how the shuttle attaches to the rail of FIG. 1;

FIG. 7 is a side perspective view of a jet bridge including rail sections of one embodiment of the present invention;

FIG. 8A is a top perspective view of a jet bridge with a plurality of rails of one embodiment of the present invention;

FIG. 8B is a close up top perspective view of rails of one section of jet bridge being received in another section of jet bridge;

FIG. 9 is a top view of a jet bridge with workers operatively connected to rails;

FIG. 10A is a top view of the connection of two rails;

FIGS. 10B and 10C are illustration of mounting plates of one embodiment of the present invention used to couple sections of rails together;

FIG. 11A is a view of a back end section of rail of one embodiment of the present invention;

FIG. 11B is an end perspective view of a backend stop of one embodiment of the present invention;

FIG. 12A is a view of a front end section of a rail of one embodiment of the present invention;

FIG. 12B is a front perspective view of an exploded frontend stop of one embodiment of the present invention; and

FIG. 12C is a front perspective view of an assembled frontend stop of FIG. 12B.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

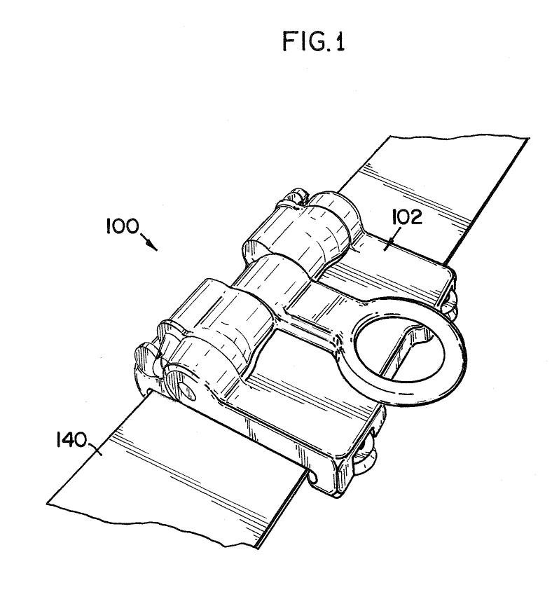

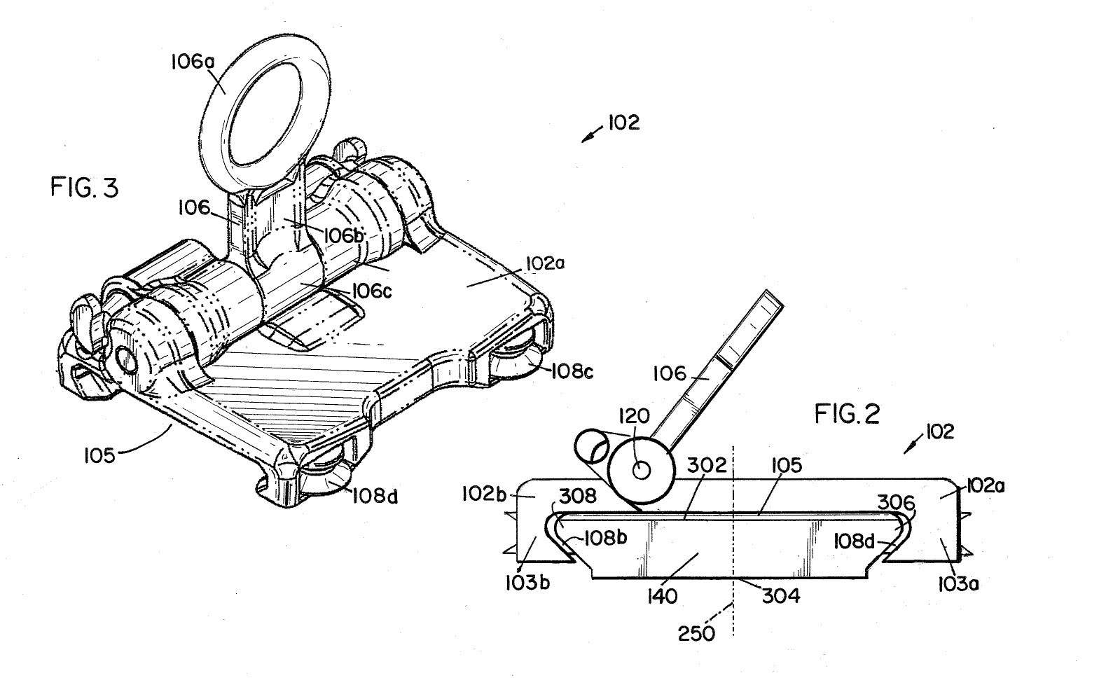

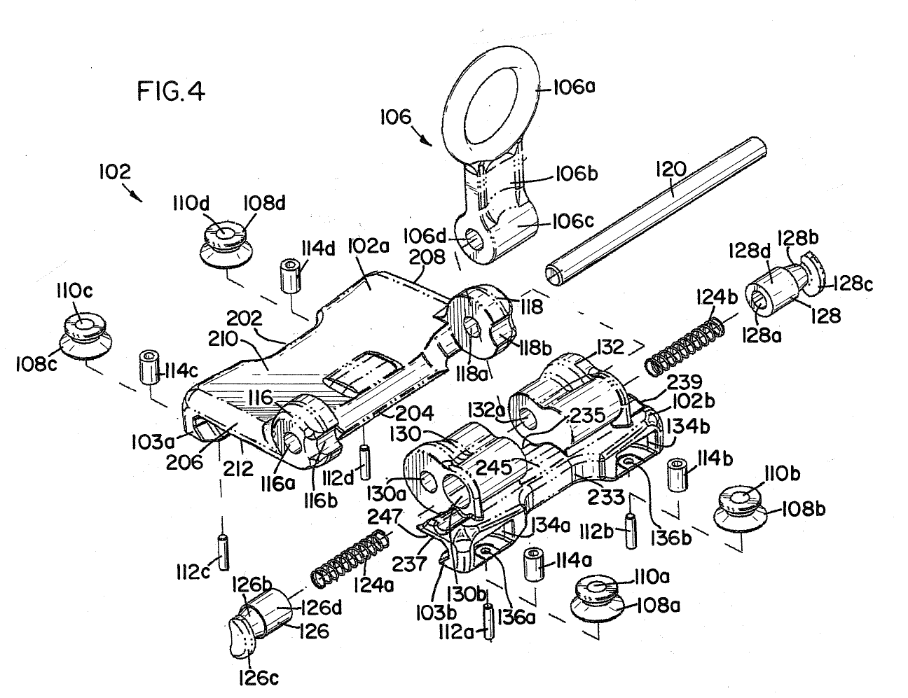

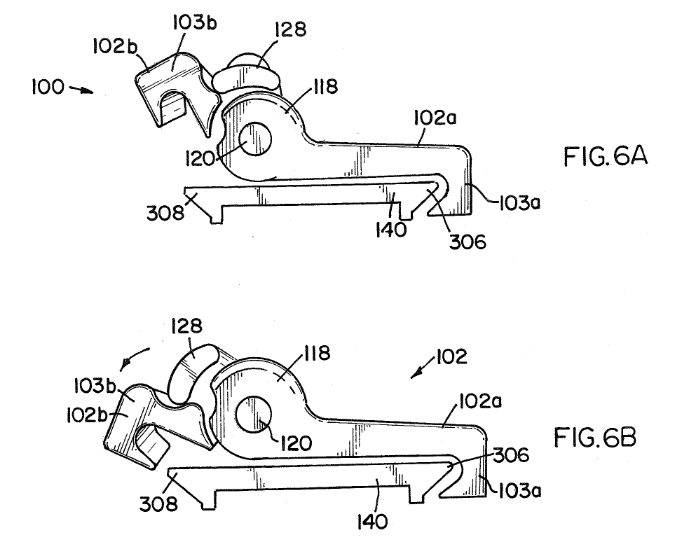

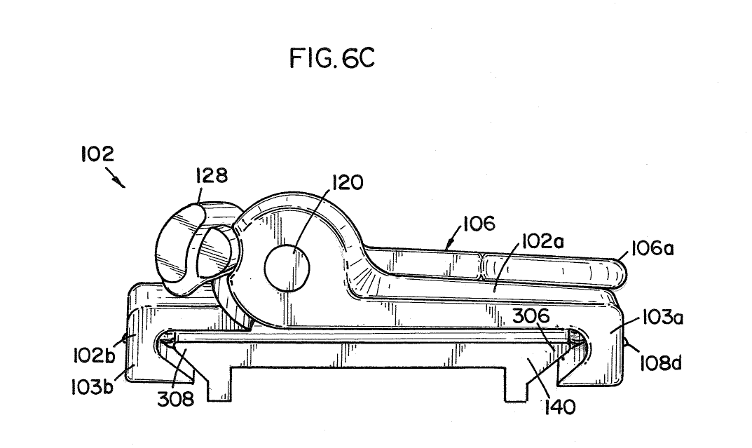

Embodiments of the present invention provide a fall protection system for workers on structures that are adjusted in length such a jet bridge. In particular, embodiments provide rails 140 that are designed to not hamper the adjustment in length of the jet bridge 160 and shuttles 100 that are designed to slidably engage the rails 140. Referring to FIG. 1, an example of a fall protection system 100 of an embodiment includes a shuttle 102 that slidably engages a rail 140. A side view of the shuttle 102 on a rail 140 is further illustrated in FIG. 2. Detailed discussions of the elements of the shuttle 102 are provided below in regards to FIGS. 3 through 5. The shuttle 102 has three main parts, a main body portion 102a, a locking body portion 102b and a connecting member 106. The locking body portion 102b is pivotally coupled to the main body portion 102a. In use, the locking body portion 102b is designed to selectively pivot in relation to the main body portion 102a to couple the shuttle 102 to the rail 140. This is further discussed in detail in relation to FIGS. 6A through 6C below. The connecting member 106 is pivotally coupled the main and locking body portions 102a and 102b. The connecting member 106 is used to couple a snap hook or carabiner connected to a lifeline (not shown) to the shuttle 102. In FIG. 2, the shuttle 102 is locked on the rail 140. To lock the shuttle 102 on the rail 104, the main body portion 102a includes a first holding portion 103a and the locking body portion 102b includes a second holding portion 103b. The first holding portion 103a and the second holding portion 103b along with respective surfaces 212 and 247 of the respective main and locking body portions 102a and 102b (designated generally in FIG. 4) form a receiving track 105 that conforms to at least a portion of the shape of the rail 140 to retain the rail 140 in the receiving track 105.

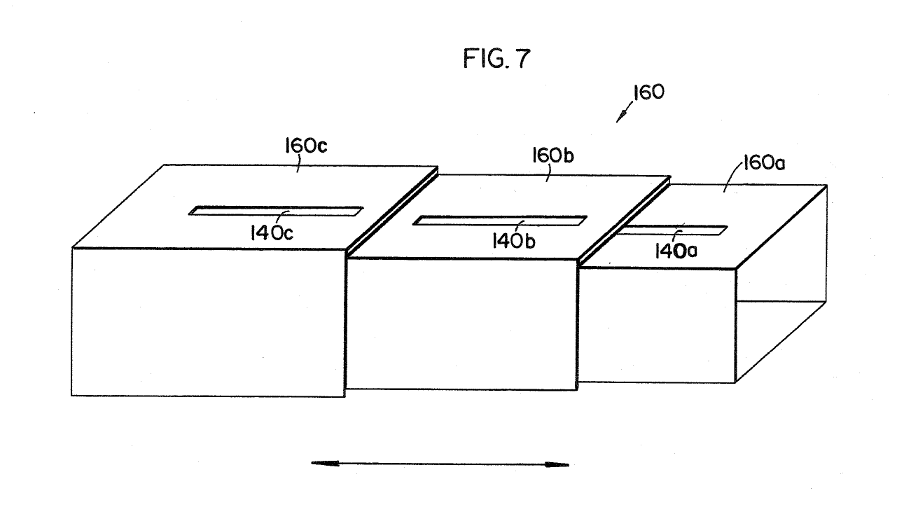

The rail 140 is an elongated rail of a select length such as elongated rails 140a, 140b and 140c illustrated in FIG. 7. In one embodiment, the height of the rail 140 is less than 0.366 inch. The relatively short height of the rail 140 allows the rail 140 to be used in locations that have relatively small clearances such as jet bridges as discussed below. Referring back to FIG. 2, the elongated rail has a first surface 302, a second surface 304, a first edge 306 and second edge 308, the width of the rail 140 across the first surface 302 is greater than the width of the rail 140 across the second surface 140 such that both the first and second edges 306 and 308 of the rail 140 generally taper in from the first surface 302 to the second surface 304. The inner surfaces of the holding members 103a and 103b of the shuttle 102 conform to the shape of the respective first and second edges 306 and 308 of the rail 140 to retain the shuttle 102 on the rail 140. The shuttle 102 also includes rollers 108a through 108d (rollers 108c and 108d are illustrated in FIG. 2) that engage the shuttle 102. The rollers 108a through 108d help the shuttle 102 slide along the length of the elongated rail 140.

A center line 250 is also illustrated in FIG. 2. The center line 250 is on a midpoint along a length of the shuttle 102. The connecting member 106 of the shuttle 102 in embodiments is pivotally coupled via connecting rod 120 at a location that is at a select distance from the midpoint 250 of the shuttle 102. The overlap distance between the shuttle and rail can be improved by increasing the distance between the rotating axis and centerline. This allows for higher forces and higher torque values on the shuttle during a fall. The pivot connection (i.e. connection rod) 120 is generally parallel to the central line. In this configuration, during a fall event, forces asserted on the shuttle 102 proximate the pivot connection will not overcome the holding forces of the holding members 103a and 103b that engage the respective first and second edges 306 and 308 of the rail 140 to pull the shuttle 102 off the track 140. Hence, off centering the pivot connection of the connecting member 106 from a midpoint of the shuttle 102 helps retain the shuttle 102 on the track 140 during a fall event.

Referring to the exploded view of shuttle 102 in FIG. 4, further discussion of the shuttle 102 is provided. As discussed above, the shuttle 102 includes a main body portion 102a. The main body portion 102a has a first side 202, a second side 204, a first end 206, a second end 208, a first surface 210 and a second surface 212. A first connector 116 (or main connector) extends from the main body member 102a proximate a first corner of the main body member 102a. The first corner of the main body member 102a is a corner defined where the first end 206 and the second side 204 of the main body member 102a meet. The first connector 116 has a first connector passage 116a that passes through the first connector 116. The first connector 116 is generally cylindrical in shape in an embodiment and has a first C-shaped groove 116b formed in a portion of its surface as illustrated in FIG. 4.

A second connector 118 extends from the main body member 102a proximate a second corner of the main body member 102a. The second corner is a corner defined where the second end 208 and the second side 204 of the main body member 102a meet. The second connector 118 has a second connector passage 118a that passes through the second connector 118. The first connector passage 116a and the second connector passage 118a are aligned. The second connector 118 is generally cylindrical in shape in an embodiment and has a second C-shaped groove 118b formed in a portion of its surface as illustrated in FIG. 4. The first C-shaped groove 116b of the first connector 116 is aligned with the second C-shaped groove 118b in the second connector 118 in an embodiment. The first holding portion 103a extends along the first side 202 of the main body portion 102a beyond the second surface 212 of the main body portion 102a. The first holding portion 103a conforms to the shape of a portion of the rail 140 as discussed above. In one embodiment the shape of the first holding portion 103a and the second surface 212 is generally C-shaped along the first side 202 of the main body portion 102a.

The locking body portion 102b has a first side 233, a second side 235, a first end 237, a second end 239, a first surface 245 and a second surface 247. A third connector 130 (or locking connector) extends from the locking body portion 102b proximate the second side 235 and the first end 237 of the locking body portion 102b. The third connector 130 is generally cylindrical in shape and has a third connector passage 130a that passes through the third connector 130. A fourth connector 132 extends from the locking body portion 102b proximate the second side 235 and the second end 239 of the locking body portion 102b. The fourth connector 132 is generally cylindrical in shape and has a fourth connector passage 132a that passes through the fourth connector 132. The first connector passage 116a of the first connector 116 and the second connector passage 118a of the second connector 116 of the main body portion 102a are aligned with the third connector passage 130a and the fourth connector passage 132a of the third and fourth connectors 130 and 132 of the locking body portion 102b. A connection rod 120 is received in the first connector passage 116a of the first connector 116, in the second connector passage 118a of the second connector 118, in the third connector passage 130a of the third connector 130 and in the fourth connector passage 132a of the fourth connector 132 to pivotally connect the main body portion 102a to the locking body portion 102b.

The third connector 130 further includes a first locking portion with a cylindrical first locking chamber 130b that has an opening facing the first end 237 of the locking body portion 102b. A first locking member 126 has a first barrel portion 126d that is slidably received in the first locking chamber 130b of the first locking portion of the third connector. The first locking member 126 further has a first engagement portion 126c and a first recessed portion 126b positioned between the first barrel portion 126d and the first engagement portion 126c of the first locking member 126. A first biasing member 124a is positioned in the first locking chamber 130b and a bore (not shown) in the first barrel portion 126d of the first locking member 126. The first biasing member 124a provides a first biasing force to bias the first locking member 126 such that the first barrel portion 126d is received in first groove 116b of the first connector 116 of the main body portion 102a thereby locking the main body portion 102a and the locking body portion 102b in a static configuration in relation to each other. Further when the first engaging portion 126c of the first locking member 126 is pressed, the biasing member 124a is compressed allowing the first recessed portion 126b to align with the first groove 116b of the first connector 116 of the main body portion 102a such that the first barrel 126d of the first locking member 126 is no longer received in the first groove 116b of the first connector 116 of the main body portion 102a.

The fourth connector 132 further includes second locking portion with a cylindrical second locking chamber (not shown) that has an opening facing the second end 239 of the locking body portion 102b. A second locking member 128 has a second barrel portion 128d that is slidably received in the second locking chamber of the second locking portion of the fourth connector 132. The second locking member 128 further has a second engagement portion 128c and a second recessed portion 128b positioned between the second barrel portion 128d and the second engagement portion 128c of the second locking member 128. A second biasing member 124b is positioned in the second locking chamber and bore 128a in the second barrel portion 128d of the second locking member 128. The second biasing member 124b provides a second biasing force to bias the second locking member 128 such that the second barrel portion 128d is received in second groove 118b of the second connector 118 of the main body portion 102a thereby locking the main body portion 102a and the locking body portion 102b in a static configuration in relation to each other. Further when the second engaging portion 128c of the second locking member 128 is pressed, the biasing member 124b is compressed allowing the second recessed portion 128b to align with the second groove 118b of the second connector 118 of the main body portion 102a such that the second barrel 128d of the second locking member 128 is no longer received in the second groove 118b of the second connector 118 of the main body portion 102a. Hence, when both the first engaging portion 126c and the second engaging portion 128c of the respective first and second locking members 126 and 128 are depressed simultaneously, the locking body portion 102b is allowed to pivot in relation to the main body portion 102a about the connection rod 120. Moreover, when the first barrel portion 126d and the second barrel portion 128d of the respective first and second locking members 126 and 128 are in the respective first and second grooves 116b and 118b of the first connector 116 and the second connector 118, the main body portion 102a is locked in a static position in relation to the locking body portion 102b.

In the locked position, the second surface 212 and the first holding portion 103a of the main body portion 102a and the second surface 247 and the second holding portion 103b form the receiving track 105 configured to envelope the rail 140. As discussed above, the second holding portion 103b extends along the first side 233 of the locking body portion 102b beyond the second surface 247 of the locking body portion 102b. The second holding portion 103b and the second surface 247 forms generally a C-shape in this embodiment along the first side 233 of the locking body portion 102b which along with the first holding portion 103a and the second surface 212 of the first holding portion form the receiving track 105.

As briefly discussed above, the shuttle further includes rollers 108a through 108d to enhance the slidability of the shuttle 102 on the rail 140. In particular, the first side 233 of the locking body portion 102b includes first and second openings to roller passages 134a and 134b. The roller passages 134a and 134b pass through the second holding portion 103b into the receiving track 105. Retaining bores 136a and 136b are formed in the second holding portion 103b. The retaining bores 136a and 136b extend to the respective roller passages 134a and 134b in generally a perpendicular manner A first roller 108a is received in roller passage 134a and a second roller 108b is received in roller passage 134b such that a portion of each of the first and second rollers 108a and 108b extend into the receiving track 105 to engage a side portion of the rail 140 that is received in the receiving track 105. The first roller 108a has a first roller central passage 110a. A first bearing 114a is received in the first roller central passage 110a. The first bearing 114a further has a first bearing central passage in which a first retaining pin 112a passes therethrough and is positioned in retaining bore 136a to retain the first roller 108a in roller passage 134a. The second roller 108b has a second roller central passage 110b. A second bearing 114b is received in the second roller central passage 110b. The second bearing 114b further has a second bearing central passage in which a second retaining pin 112b passes therethrough and is positioned in retaining bore 136b to retain the second roller 108b in roller passage 134b. The third and fourth rollers 108c and 108d are similarly received in roller passages through the first holding portion 103a of the main body member 102a. In particular, first and second bearings 114c and 114d are received in respective third and fourth central passages 110c and 110d and retaining pins 112c and 112d passing through respective retaining bores (not shown) rotationally mount the third and fourth rollers 108c and 108d in the roller passages such that a portion of each third and fourth roller 108c and 108d engages a side portion of the rail 140 received in the receiving track 105 formed by the main and locked body portions 102a and 102b.

The connection member 106 includes a base portion 106c having a connecting member passage 106d. The base portion 106c is positioned between the third and fourth connectors 130 and 132 of the locking body portion 102b. The connecting member passage 106d of the base portion is aligned with the first connector passage 116a of the first connector 116 and the second connector passage 118a of the second connector 116 of the main body portion 102a and the third connector passage 130a and the fourth connector passage 132a of the locking body portion 102b. The connecting rod 120 passes through the connecting member passage 106d of the connecting member 106 providing a pivot connection between the connecting member 106 and the main body portion 102a and the locking body portion 102b. The connecting member 106 further has a connecting looped portion 106a designed to engage a snap hook, carabiner or the like that is attached to a safety harness of a user via a lifeline. Hence, the connecting looped portion 106a provides a connection point to the shuttle 102. The connecting member 106 further has an elongated portion 106b that connects the base portion 106c to the looped portion 106a.

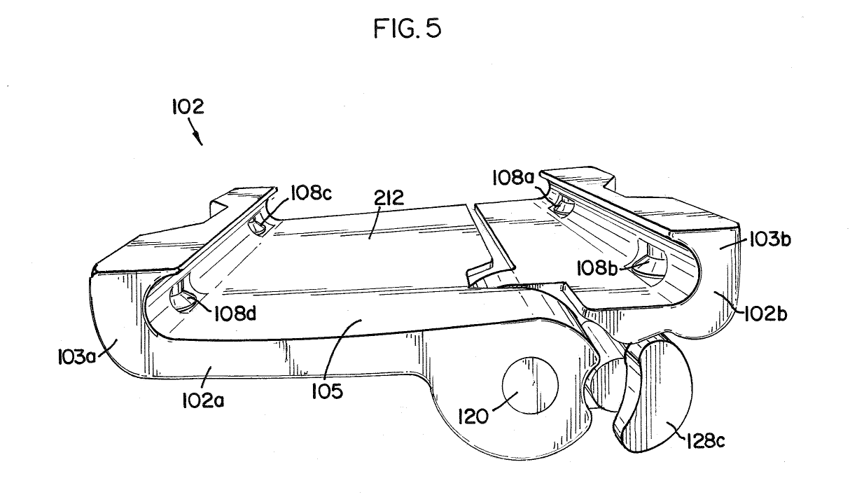

FIG. 5 is a bottom perspective view of the shuttle 102 further illustrating the receiving track 105 formed when the shuttle 102 is in a locked position. Also illustrated are portions of rollers 108a through 108d extending into the receiving track portion 105. FIGS. 6A through 6C illustrate how the shuttle 102 is attached to the rail 140. In FIG. 6A, both first and second locking members 126 and 128 (not shown in this Figure) have been simultaneously depressed thereby allowing the locking body portion 102b to pivot in relation to the main body portion 102a. In the position illustrated in FIG. 6A, the main body portion 102a is placed on rail 140 so the first holding portion 103a envelopes the first edge 306 of the rail 140. Once, the main body portion 102a is positioned, the locking body portion 102b is rotated towards the rail 140 as illustrated in FIG. 6B. The locking body portion 102b is rotated until the barrels 126d and 128d of the first and second locking members 126 and 128 are received in the respective first and second grooves 116b and 118b in the respective first and second connectors 116 and 118. In this position, the second holding member 103b engages the second edge 308 of the rail 140 thereby locking the shuttle 102 on the rail 140, as illustrated in FIG. 6C. To remove the shuttle 102, the first and second locking member 126 and 128 are simultaneously depressed, thereby releasing the second holding member 103b of the locking body portion 102b from the second edge 308 of the rail 140.

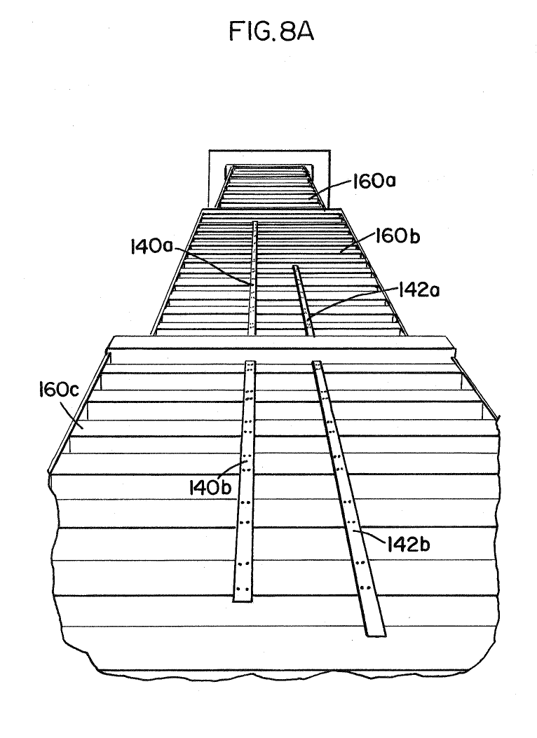

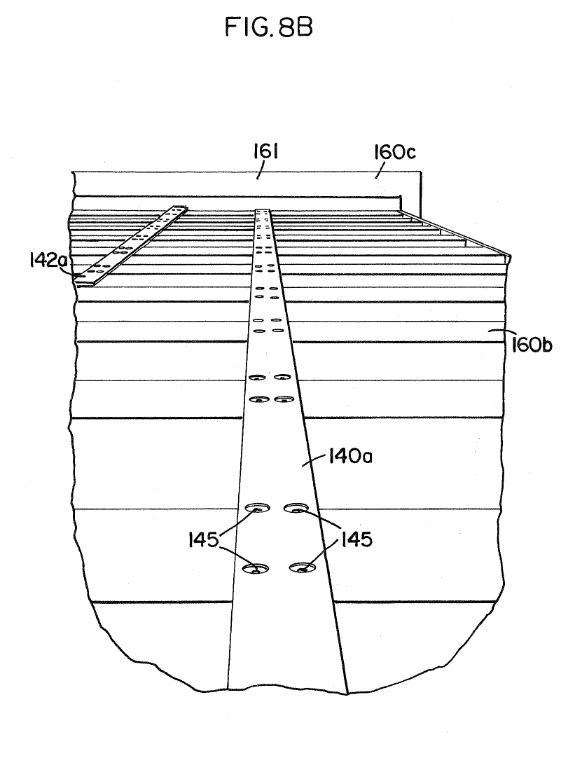

As briefly discussed above, FIG. 7 is a side perspective view of a structure 106 that changes in length such as a jet bridge. The jet bridge 160 in this example has three sections 160a, 160b and 160c. Section 160a is designed to slide into and out of section 160b. Similarly, section 106b is configured to slide into and out of section 160c. Hence, the overall length of the jet bridge 160 can be adjusted by the positioning of the sections 160a, 160b and 160c in relation to each other. Also illustrated in FIG. 7, are rail sections 140a, 140b and 140c that are coupled to the top of the respective jet bridge sections 160a, 160b and 160c. Each rail section 140a, 140b and 140c may be made of a plurality of rail subsections that are coupled together as illustrated in FIG. 10A and described below to foam the respective rail sections 140a, 140b and 140c. FIG. 8A is a top view of a jet bridge having sections 160a, 160b and 160c. In this example embodiment, two sets of rails are used. In particular, a first rail system includes sections 140a and 140b and a second rail system includes 142a and 142b. Hence, embodiments allow for more than one rail system. Moreover, in one embodiment, each rail section 140a, 140b, 142a and 142b are made from a material that has sufficient strength to hold more than one user during multiple fall events. Example materials used include, but are not limited to aluminum alloys such as 6061-T6 and 7075-T6, or stainless steels. Referring to FIG. 8B a close up top perspective view of rails 140a and 142a connected to section 160b of the jet bridge with fasteners 145 is illustrated. FIG. 8B also illustrates how the rails 140a and 142a that are connected to section 160b fit under a top portion 161 of section 160c so as to not hamper the movement of the respective sections 160a, 160b and 160c in relation to each other. Hence, this is one reason the rail 140 is designed to have a relatively short height.

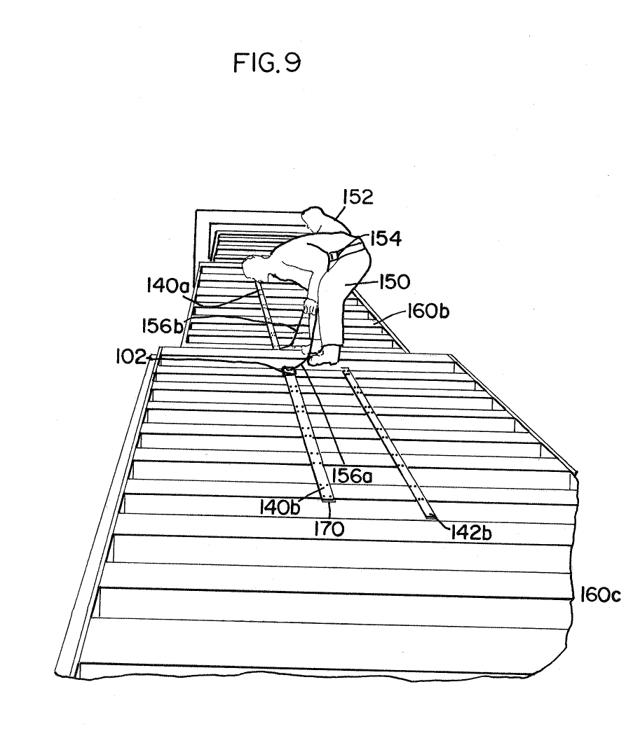

FIG. 9 illustrates two workers 152 and 154 (or users) coupled to the two different rail systems 140a, 140b and 142a and 142b. In typical use, a worker will have two separate shuttles 102 coupled to their respective safety harness. When a worker 154 needs to move from one section 160c to another section 160b of the bridge, the worker simply attaches a second one of his or her shuttles 102 to the rail 140a that is coupled to the section 106b of the jet bridge the worker wants to move to when the respective rail 140a is within the workers reach. Once the second one of the shuttle 102 is connected to rail 140a, the worker's first shuttle 102 is then unlocked and detached from the rail 140b attached to the section 106c of the jet bridge the worker is leaving. This way the worker 154 is always attached to a lifeline.

The length of each rail can be extended by using more than one rail section or sub-section. For example, referring to FIG. 10A a top view of two rail sub-sections 140-1 and 140-2 coupled together is illustrated. An attaching plate 164, as illustrated in FIGS. 10B and 10C, is used to couple the rail sub-sections 140-1 and 140-2 together. In particular, plate 164 is positioned on an inside surface of a top portion 161 of a jet bridge section 160. Plate 164 is coupled to the respective rails 104-1 and 140-2 via fasteners passing through plate apertures 166, apertures in the top portion 161 of the jet bridge section 160. Fasteners 145 passing through rail sections 140-1 and 140-2 threadably engage fasteners 168 to couple the rail sub-section 104-1 and 140-2 together. Plate 164 is relatively thin so as to not hamper the retraction and extension of sections of the jet ramp bridge.

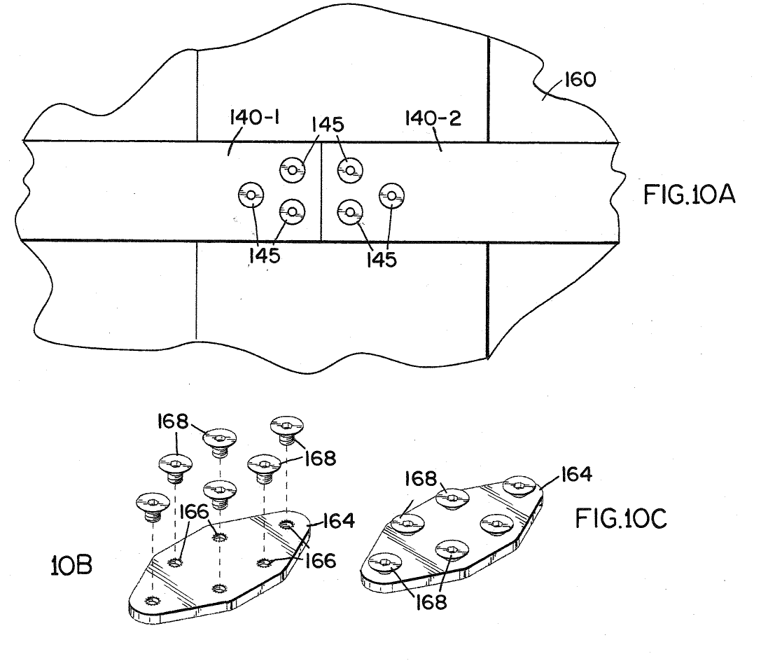

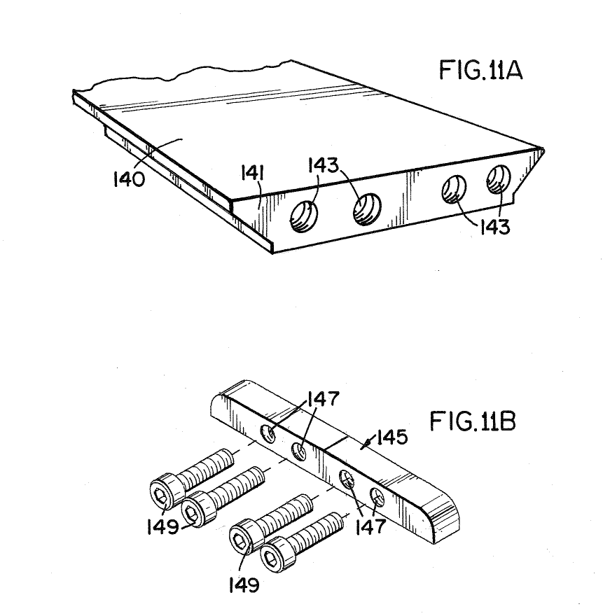

To make sure the shuttle does not run off an end of a rail 140, rail stops are used. In particular backend stops 145 are used for back ends 141 of a rail 140 and frontend stops 180 are used for a front ends 179 of a rail 140 in an embodiment. Referring to FIG. 11A, a back end of rail 140 is illustrated. The back end includes threaded apertures 143. A backend stop 145 is further illustrated in FIG. 11B. Fasteners 149 having external threads pass through apertures 147 in the backend stop 145 and threadably engage threaded bores 143 in the back end 141 of the rail 140 to couple the backend stop 145 to the rail 140. The backend stop 145 prevents the shuttle 102 from coming off the back end 141 of the rail 140. In embodiments, the backend stop 145 and the connection to the rail are designed strong enough so that the shuttle 102 will remain on the rail 140 during a fall event that exerts forces on the backend stop 145.

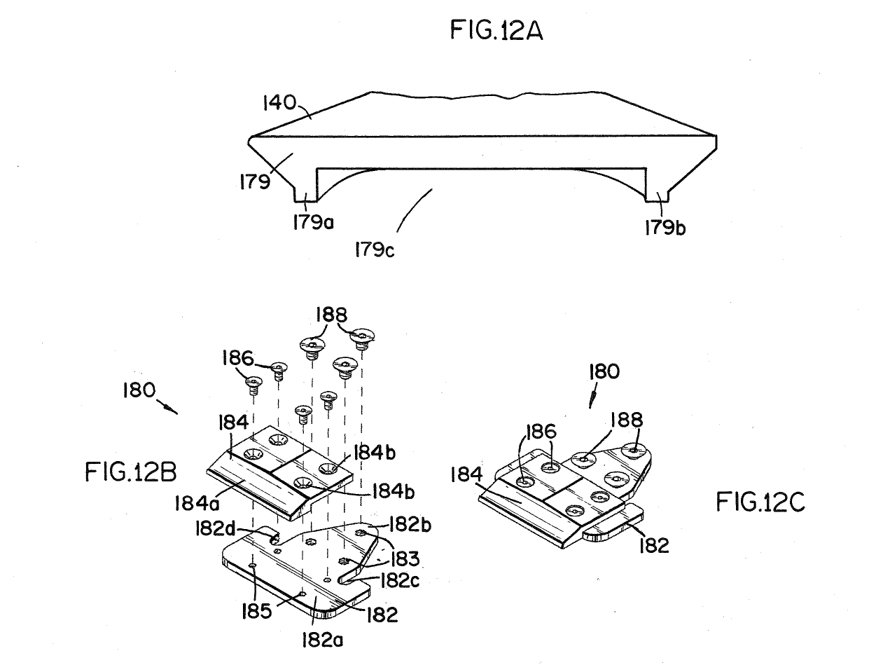

A front end 179 of a rail 140 is illustrated in FIG. 12A. The front end 179 of the rail 140 also includes a stop as stated above. In particular, a frontend stop 180 is illustrated in FIGS. 12B and 12C. The frontend stop 180 includes a base plate 182 and a ramp plate 184. The base plate 182 has a first portion 182a and a second portion 182b. The first portion 182a has a plurality of apertures 185. Fasteners 186 passing through apertures 184b in the ramp plate 184 are used to couple the ramp plate 184 to the first portion 182a of the base plate 182 via apertures 185. The ramp plate 184 includes a ramp surface 184 that is designed so that the frontend stop 180 with not get caught on any part of a section 160 of a jet bridge when the jet bridge is retracting. The second portion 182b of the base plate 183 extends from the first portion 182a and is designed to fit in a slot 179c in the front end 179 of the rail 140. In addition, feet sections 179a and 179b of the front end 179 of the rail 140 are designed to be received in slots 182c and 182d of the base plate 182. Fasters 188 pass through apertures in the rail and threadably engage threaded apertures 182c in the second section 182 of the base plate 182 to couple the frontend stop 180 to the front end 179 of the rail 140. Similar to the construction of the backend stop 145 of the rail, the front end stop 180 is designed to be strong enough to retain the shuttle on the rail 140 during a fall event that exerts forces on the frontend stop 180.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A fall protection system comprising:
at least one rail section configured and arranged to be coupled to a structure that changes in length;
at least one shuttle configured and arranged to slidably engage the at least one rail section; and
at least one connecting member configured and arranged to provide a connection point to the at least one shuttle.

2. The fall protection system of claim 1, further comprising:
at least one end stop configured and arranged to prevent the at least one shuttle from sliding off of an end of the at least one rail section.

3. The fall protection system of claim 1, wherein each rail section further comprises:
opposed first and second edges and opposed first and second surfaces, a height of the rail defined by the distance between the first surface and the second surface, the first surface having a first width defined by the distance between the first and second edges, the second surface having a second width defined by the distance between the first and second edges, wherein the first and second edges taper in from the first surface to the second surface, the second surface configured and arranged to engage a surface of the structure.

4. The fall protection system of claim 3, wherein the height of the rail is less than 0.366 of an inch.

5. The fall protection system of claim 3, wherein the at least one shuttle further comprises:
a main body portion having opposed first and second sides, the main body portion having
a first holding member extending along the first side of the main body portion, the first holding portion configured and arranged to fit around the first edge of the at least one rail section;
a locking body portion having opposed first and second sides, the first side of the locking body portion pivotally coupled to the second side of the main body portion, the locking body portion having a second holding member extending along the second side of the locking body portion, the second holding member configured and arranged to fit around the second edge of the at least one rail section; and
at least one locking member configured and arranged to selectively lock the locking body portion in a static position in relation to the main body portion, wherein when the locking portion is locked in a static position in relation to the main body portion, the shuttle forms a receiving track portion configured and arranged to receive the at least one rail section.

6. The fall protection system of claim 5, further comprising:
at least one main body roller rotationally coupled to the first holding member of the main body portion, wherein the at least one main body roller is configured and arrange to engage the first edge of the at least one rail to enhance movement of the at least one shuttle along the at least one rail; and
at least one locking body roller rotationally coupled to the second holding member of the locking body portion, wherein the at least one locking body roller is configured and arrange to engage the second edge of the at least one rail to enhance movement of the at least one shuttle along the at least one rail.

7. A fall protection assembly comprising:
at least one elongated rail configured and arranged to be coupled to a section of a structure that changes length; and
at least one shuttle configured and arranged to slidably engage the at least one track, each shuttle including,
a main body portion,
a locking body portion pivotally coupled to the main body portion, the locking body portion configured to selectively pivot in relation to the main body portion to selectively engage and disengage the at least one elongated member, and
a connecting member pivotally coupled to the main body portion configured and arranged to provide a connection point to the at least one shuttle.

8. The fall protection assembly of claim 7, the at least one shuttle further comprising:
the main body portion including a first side, a second side, a first surface and a second surface, the main body portion further including,
a first holding portion extending along the first side of the main body portion beyond the second surface of the main body portion, the first holding portion configured to envelope a first edge of the at least one track member; and
the locking body portion including a first side, a second side, a first surface and second surface, the locking body portion further including,
a second holding portion extending along the first side of the locking body portion beyond the second surface of the locking body portion, the second holding portion configured to selectively envelope a second edge of the at least one track member, wherein the first holding portion and the second surface of the main body portion and the second holding portion and the second surface of the locking body portion selectively form a receiving track to receive the at least one elongated rail.

9. The fall protection assembly of claim 8, wherein the connecting member extends from the first surface of the main body portion.

10. The fall protection assembly of claim 9, wherein the at least one shuttle has a midpoint halfway between the first holding portion of the main body portion and the second holding portion of the locking body portion, the connecting member coupled to the shuttle at a select distance away from the midpoint.

11. The fall protection assembly of claim 7, wherein the at least one elongated rail further includes a first surface, a second surface, a first edge and a second edge, the width of the rail across the first surface being wider than the width of the rail across the second surface such that both the first and second edges of the at least one elongated rail taper in from the first surface to the second surface, the second surface of the at least one elongated rail configured and arranged to engage a surface of the structure.

12. The fall protection assembly of claim 1, further comprising:
at least one end stop coupled to at least one end of the at least one elongated rail to prevent the shuttle from sliding off an end of the at least one elongated rail.

13. The fall protection assembly of claim 12, wherein the at least one end stop is a backend stop configured and arranged to be engaged with a respective end of the at least one elongated rail.

14. The fall protection assembly of claim 12, wherein the at least one end stop is a frontend stop, the frontend stop including a ramp portion configured and arranged to prevent an end of an associated elongated rail from catching up on a retracting section of the structure.

15. A shuttle for a fall protection assembly comprising:
a main body portion having opposed first and second sides, the main body including,
a first holding member extending along the first side of the main body portion, the first holding portion configured and arranged to fit around a first edge of a rail, and
at least one main connector coupled proximate the second side of the main body portion,
a locking body portion having opposed first and second sides, the locking body portion including,
a second holding member extending along the first side of the locking body portion configured and arranged to fit around a second edge of a rail, and
at least one locking connector coupled proximate the second side of the locking body portion, the at least one locking connector pivotally coupled to the at least one main connector of the main body portion;
at least one locking member configured and arranged to selectively lock the locking body portion in a static position in relation to the main body portion; and
a connector coupled to the shuttle configured and arranged to provide a connection point to the shuttle.

16. The shuttle of claim 15, further comprising:
the at least one main connector of the main body portion including a groove; and
the at least one locking member being movably coupled to the locking portion body, the at least one locking member selectively received in the groove of the at least one main connector to lock the locking body in a static position in relation to the main body portion.

17. The shuttle of claim 16, further comprising:
the at least one locking connector of the locking body portion including a locking chamber;
the at least one locking member having an engagement portion, a barrel portion and a recessed portion, the recessed portion extending between the engagement portion and the barrel portion, the barrel portion having a bore, the barrel portion movable coupled in the locking chamber of the at least one locking connector; and
a biasing member for each locking member, each biasing member received in the bore in the barrel of an associated locking member, the bias member providing a biasing force on the associated locking member to retain the barrel portion of the associated locking member in a groove of an associated main connector to lock the locking body portion in a static position in relation to the main body portion, wherein a force on the engagement portion of the associated locking member counters the biasing force to position the recessed portion about the groove of the associated main connector to allow the locking body portion to pivot in relation to the main body portion.

18. The shuttle of claim 15, further comprising:
at least one main body roller rotationally coupled to the first holding member of the main body portion, wherein the at least one main body roller is configured and arrange to engage the first edge of the rail to enhance movement of the shuttle along the rail; and
at least one locking body roller rotationally coupled to the second holding member of the locking body portion, wherein the at least one locking body roller is configured and arrange to engage the second edge of the rail to enhance movement of the shuttle along the rail.

19. The shuttle of claim 15, wherein the connector further comprises:
a base portion rotationally coupled to the main body portion of the shuttle;
a connection loop; and
an elongated member extending between the base portion and the connection loop.

20. The shuttle of claim 19, wherein the shuttle has a select width, the width defined between the first holding member extending along the first side of the main body portion and the second holding member extending along the first side of the locking body portion, the shuttle further having a midpoint along the width, the base portion rotationally coupled to the main body portion a select distance from the midpoint of the shuttle.
